(19) United States
(12) Patent Application Publication
(10) Pub. No.: US 2003/0143301 A1
(43) Pub. Date: Jul. 31, 2003

(54) Mold apparatus for producing tablets

(76) Inventor: Richard A. Ozment, Sugar Land, TX (US)

Correspondence Address: CONLEY ROSE, P.C., P. O. BOX 3267, HOUSTON, TX, 77253-3267, US

(21) Appl. No.: 10/352,761

(22) Filed: Jan. 28, 2003

Related U.S. Application Data
(60) Provisional application No. 60/352,608, filed on Jan. 29, 2002.

(51) Int. Cl. B28B 1/00

(52) U.S. Cl. 425/406

(57) ABSTRACT

A method and apparatus for producing tablets from compounds includes a mold plate having a plurality of rows and columns of holes therethrough for receiving the compound and a receptor plate having retaining members for retaining the mold plate against the base of the receptor plate. The mold and receptor plates may be made from aluminum or stainless steel, and the mold plate may also be made from a high density polymer. The perimetrical edges of the receptor plate may be configured so as to form longitudinal slots to receive the edges of the mold plate via a sliding action. The retaining members provide a clamping action to apply pressure between the two plates, thereby preventing seepage between the plates after the holes are filled with compound.

### CROSS-REFERENCE TO RELATED APPLICATIONS

The present application claims the benefit of 35 U.S.C. §111(b) Provisional Application Serial No. 60/352,608 filed Jan. 29, 2002, and entitled “Mold Apparatus for Producing Tablets”.

### STATEMENT REGARDING FEDERALLY SPONSORED RESEARCH OR DEVELOPMENT

Not applicable.

### BACKGROUND OF THE INVENTION

1. Field of the Invention

The present invention relates generally to the manufacture of tablets. More particularly, the present invention relates to a method and apparatus for forming and maintaining the integrity of medicinal compound during the manufacture of medication tablets. More particularly still, the present invention relates to a method and apparatus for manufacturing tablets at an optimal level of output and efficiency.

### BACKGROUND OF THE INVENTION

Oftentimes there is a need to produce small batches of tablets such as specialized medicines in tablet form. Such tablets may be triturates having a fine medicinal powder mixed with lactose for use as medicine which is more palatable for consumption. The process is called compounding medicine into tablets. For example pharmacists and veterinarians may wish to prepare a specialized compound to be produced as a tablet to treat animals. Likewise, pharmacists and physicians may wish to produce a medicinal compound in tablet form to treat their human patients. Thus pharmacists, veterinarians, physicians and the like have a need to produce medicine which can be compounded and molded into tablet form quickly and in relatively small quantities. The compound is made from a recipe or prescription including a medicinal in a preferred dosage to produce a tablet for use. The tablet may be of a common size but the dosage of medicine in the tablet may vary with the prescription. The finished product may also be called a pellet.

Various methods and apparatus have been used to produce small tablet quantities. Such apparatus are usually much different than apparatus used for the mass production of medicinal tablets. For example, some small tablet quantities are produced by preparing the medicinal compounds in dough form which is rolled and cut out with a cookie cutter like instrument to form discs which are dried and then packaged.

Other oral triturates may be produced in a mold and then pressed out of the mold in tablet form. One type of mold includes a rigid plate with predetermined thickness having a plurality of circular holes extending through the plate. The medicine is compounded with a gelatin type material producing a medicinal compound with a gelatin type consistency. The medicinal compound is prepared by mixing the medicine in a powder form with a gelatin of a material or food which tastes good to the consumer, whether that be human or animal. The medicine may be in liquid, gelatin, or powder form. Preferably, the compound has a consistency allowing the compound to be spread onto the mold and spread into the holes in the plate filling each hole with compound. Once the compound is in the mold, the mold and compound are dried or cooled causing the compound to enhance its consistency into a solid so that the tablets can be removed from the mold. Typically the mold with compound is placed in a freezer for several minutes. After a few minutes, the compound solidifies and the tablets are punched out through the holes in the mold. The tablets may be punched out individually, or a jig having a plurality of pegs matching the holes in the mold may be used to punch the tablets out of the holes. The individual tablets are then packaged.

One prior art mold device is a two-piece mold including a mold plate fastened to a base plate. The mold and base plates may be made of stainless steel, aluminum metal, or a plastic such as a high density polyethylene. Metal plates tend to be more expensive than plastic plates. The base plate is a solid base plate and acts as a removable bottom for the mold plate. The mold plate has a predetermined thickness and has a plurality of circular holes extending through the plate. In one prior art device, the mold is ¾ inch thick and the base is ¼ inch thick.

The mold plate is positioned on top of the base plate and some means is provided for connecting the two plates in order to prevent the compound from leaching or seeping from between the two plates before the compound is set in tablet form. Pressure must be applied between the plates to minimize any clearance between the plates which would allow seeping of the compound. Thus, fastening means must be provided to fasten the mold plate to the base plate with sufficient pressure to adequately seal the bottoms of the holes in the mold plate and prevent leaching therebetween.

One type of fastener includes the use of a plurality of bolts, typically six, extending through apertures around the perimeter of the mold plate and through aligned bores in the perimeter of the base plate. The nuts can then be tightened onto the bolts to achieve the necessary sealing engagement of the two plates to prevent seepage. Alternatively, screws may extend through the mold plate and thread into threaded bores in the base plate.

In using the two-piece mold, the mold plate is mounted onto the base plate and the mold plate is bolted or screwed to the base plate. The bolts or screws are threaded tightly because if they are not tight, the compound will leach out from underneath the mold plate. The compound is mixed and spread into the holes in the mold plate. The mold and base plates are then put into a freezer allowing the compound to set up. The mold and base plates are then removed from the freezer and the mold plate is removed from the base plate by unthreading the bolts or screws. With the base plate removed, the pills or tablets can then be punched out of the mold plate because the compound has solidified while in the freezer. Where the mold and base plates are metal, the holes in the mold plate may be waxed to assist in removing the tablets from the holes.

The use of bolts or screws has a number of disadvantages. It is necessary to keep the mold plate tight all the way around its circumference to avoid leaching with the compound running out from underneath the mold. It is not necessary that the base plate be sealed to the mold plate since the compound does have some consistency. One of the problems with bolts or screws is that the clamping force is very localized. In some of the prior art molds, 8 screws may be required to keep the two parts connected together tightly enough to avoid leaching. Bolts or screws also increase the number of parts required and amount of materials needed for the mold assembly.

Another one of the problems of the prior art is that the bolts and screws must be taken out of the mold and then put back in after each use. Since the base plate must be removed from the mold plate to remove the tablets, the use of bolts or screws is very time consuming in that it is cumbersome to remove all of the bolts or screws each time the tablets are to be removed from the mold plate and then have to reconnect all of the bolts and screws to connect the mold and base plates for the next batch of tablets.

Also bolts and screws are harder to clean and keep clean. The bolts or screws may be thumb fasteners which are very expensive. Nuts for the bolts are also expensive.

Another problem with using bolts or screws is that it is necessary to get the holes aligned exactly for the bolts and screws. When the holes are not lined up properly, the mold and base plates will not go back together properly. Identifying marks have to be used to be sure that the proper holes are aligned with each other.

Another type of fastener includes the use of clamps for clamping the mold plate to the base plate. Separate fasteners are not nearly as clean or as smooth in operation as a sliding fit. Also clamps require separate apparatus which adds cost. Further, this method tends to be clumsy and inefficient.

Where the compound tends to have a more liquid consistency, such as with medicine for human use, leaching is a greater problem and it is preferred that the medicinal compound did not leach from one hole into another hole in the mold. Metal molds may include mating protuberances and grooves or notches milled in the plates to prevent the leaching. The engaged protuberances and grooves also assist in holding the plates in place and together. Typically the protuberances and grooves are located around the perimeter of the plates in the prior art. The mating plates with mating protuberances and grooves are then screwed down tight enough so that there is no leaching between adjacent holes.

A mold apparatus that eliminates the need for manual clamping action while simultaneously providing pressure between the two plates is highly desirable. The present invention overcomes the deficiencies of the prior art.

### BRIEF SUMMARY OF THE INVENTION

The mold assembly of the present invention includes a mold plate having a plurality of rows and columns of holes therethrough and a receptor plate having retaining members. Preferably the retaining members include a retaining edge connected to the base by a retaining wall.

Preferably, the receptor plate perimeter is configured so that the single-piece receptor plate acts simultaneously as a receptor and as a clamping device for the mold plate. The mold plate then engages the receptor plate via a sliding action, thereby creating the necessary clamping action. Preferably, the mold plate is made from stainless steel or aluminum. Alternatively, the mold plate may be made from a high density polymer such as polyethylene or polyurethane.

These and other advantages of the present invention will become apparent on reading the detailed description of the invention in conjunction with the drawings.

### BRIEF DESCRIPTION OF THE DRAWINGS

For a detailed description of the preferred embodiments of the invention, reference will now be made to the accompanying drawings in which:

FIG. 1 is a plan view of the mold plate of the present invention;

FIG. 2 is a plan view of the receptor plate of the present invention;

FIG. 3 is a front elevation view of the receptor plate of FIG. 2;

FIG. 3A is an end view of an alternative retaining member on the receptor plate of FIG. 2;

FIG. 3B is an end view of another alternative retaining member for the mold and receptor plates of FIGS. 1 and 2;

FIG. 4 is an exploded view of the mold plate and receptor plate prior to assembly; and

FIG. 5 is a schematic side elevation view of a tool for removing the tablets into packaging.

### Notation and Nomenclature

Certain terms are used throughout the following description and claims to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION OF THE PREFERRED EMBODIMENTS

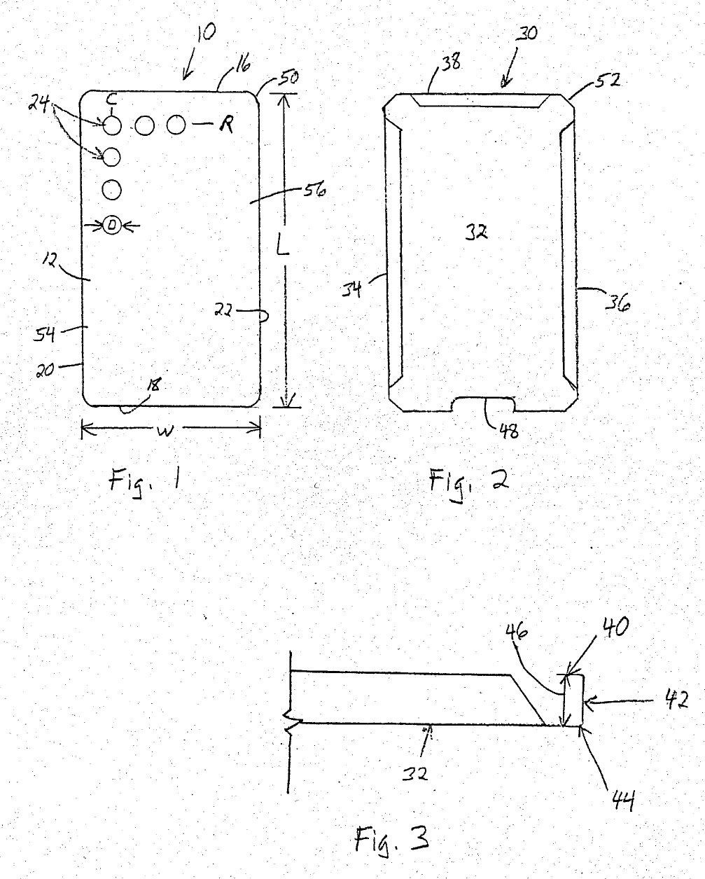

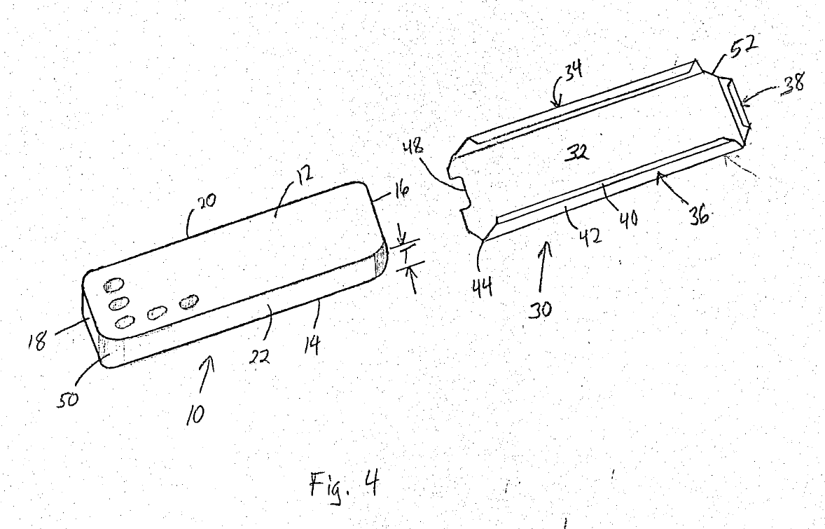

Referring to FIGS. 1-4, there is shown a mold assembly including a mold plate 10 shown in FIG. 1 and a receptor plate 30 shown in FIG. 2. Referring now to FIGS. 1 and 4, the mold plate 10 is a generally rectangular member having a width W, a length L, and a thickness T with a top 12, a bottom 14, two ends 16, 18 and two sides 20, 22. Holes 24 are drilled in columns C and rows R through the top and bottom 12, 14 of mold plate 10. The dimensions of mold plate 10 are dependent on the number of holes 24 required to produce a predetermined number of tablets. Preferably the holes 24 are round having a predetermined diameter D. It should be appreciated, however, that the holes 24 may have any desired cross-section. Also the configuration of the mold assembly is not imperative.

The size of the tablets dictate the dimensions of mold plate 10 and holes 24. There are two standard tablets, a one gram tablet and a two gram tablet. The thickness T of the mold plate 10 and the diameter D of the holes 24 serve as a measuring gauge for the size of the tablet, i.e. whether it is a one gram or two gram tablet. For example, a mold assembly which produces 100 two gram tablets has five columns C and 20 rows R of holes 24 having approximately a 7/16 inch (1.1 cm) diameter D. The width W is approximately 6 inches (15 cm), the length L is approximately 13 inches (33 cm), and the thickness T is ½ inch (1.2 cm). A mold assembly which produces 100 one gram tablets has the same dimensions except that the thickness T of mold plate 10 is only ¼ inch. Preferably the diameter D of the hole 24 is the same in both the ¼ inch and ½ inch thick mold plates. It is preferred that the mold plate 10 be thinner with an enlarged hole diameter to hold the same volume of medicinal compound as prior art molds which tend to be thicker, such as ¾ inch.

The holes 24 are preferably equidistantly apart by being drilled using a computer driven CNC drill. Thus, all the holes 24 have an exact size, are in alignment in the rows R and columns C, and are an exact distance apart in rows R and columns C. Preferably, the rectangular dimensions W, L, and T are also exact to facilitate removal of the medicinal tablets after cooling, such as by the use of a tool to punch out a row or all of the tablets at one time.

The mold plate 10 may be made from various materials. Preferably, the mold plate 10 is made from stainless steel or aluminum, but may be made from a high density polyethylene. One preferred material is stainless steel, particularly 304 stainless steel, because it is more clinically pure. It is easier to keep clean and is preferred by pharmacists. Also stainless steel or aluminum will last a lifetime. The high density polyethylene is also preferred because it does not discolor with use and is just as easy to clean as is the aluminum.

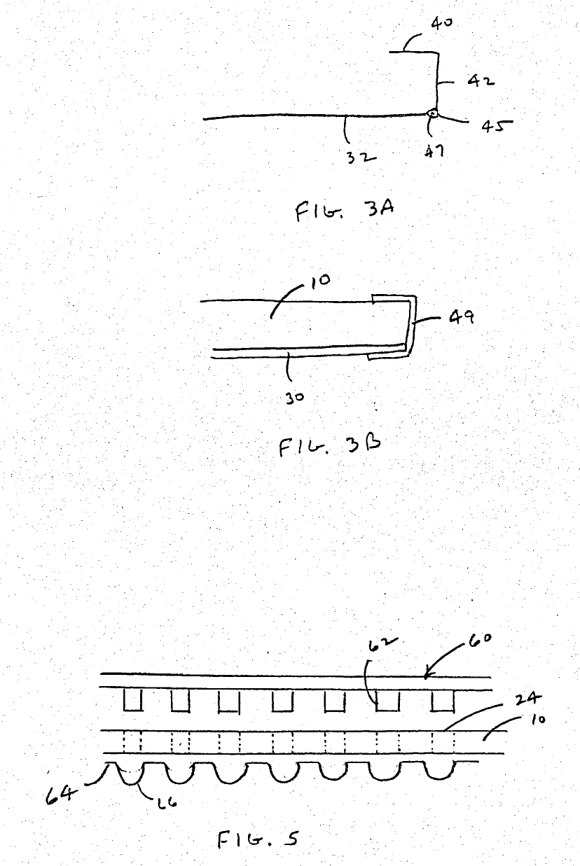

Referring now to FIGS. 2 and 3, the receptor plate 30 functions both as a base and a retaining member for the mold plate 10. The receptor plate 30 includes a base 32, side retaining members 34, 36 and end retaining member 38. Receptor plate 20 is preferably dimensioned to receive, engage and retain mold plate 10 to receptor plate 30. Base 32 is dimensioned to cover the bottom 14 of mold plate 10 and is therefore generally rectangular.

Referring now to FIG. 3, retaining members 34, 36, 38 are dimensioned to slidingly receive the top and bottom edges 54, 56 of mold plate 10 and hold mold plate 10 against the base 32 of receptor plate 30. Retaining members 34, 36, 38 include a retaining edge 40 connected to the base 32 at junction 44 by a retaining wall 42. Retaining edge 40 and base 32 provide a predetermined clearance 46 dimensioned to slidingly receive and engage the edges 54, 56 of mold plate 10 when the user slides mold plate 10 into place within retaining members 34, 36, 38 of receptor plate 30. Predetermined clearance 46 is substantially the same as, or possibly less than, the thickness T of mold plate 10 to cause retaining edge 40 to exert a clamping force onto the edges 54, 56 of mold plate 10. In one embodiment, the thickness T of mold plate 10 is greater than the clearance 46 causing the edges 54, 56 of mold plate 10 to expand the retaining edge 40 outwardly thereby causing the retaining edge 40 and retaining wall 42 to apply a clamping force onto mold plate 10. The clearance 46 has a tolerance to slidingly receive the edges 54, 56 of the mold plate 10 and provide a sliding fit between the mold plate 10 and the retaining members 34, 36, 38 of receptor plate 30. It should be appreciated that the edges 54, 56 of the mold plate 10 may be reduced, such as by grinding, to achieve a proper thickness at edges 54, 56 and thus the desired sliding fit between plates 10, 30. Thus the clearance 46 must not only allow the mold plate 10 to slide within the retaining members 34, 36, 38 of receptor plate 30 to allow the receptor plate 30 to be inserted and removed, but the clearance 46 must provide a sufficient holding of the edges 54, 56 to cause the bottom 14 of the mold plate 10 to engage the base 32 of the receptor plate 30 so as to prevent leaching.

Base 32, retaining edge 40 and retaining wall 42 operate together to guide, stabilize, and exert force upon mold plate 10 as mold plate 10 slides into place. Retaining edge 40 forms a lip which provides a continuous clamping force along each edge 54, 56 of the mold plate 10 holding the bottom 14 of mold plate 10 against the base 32 of receptor plate 30. The width of retaining edge 40 need only be wide enough to have sufficient surface contact with the edges 54, 56 of mold plate 10 to provide adequate clamping action. Although the retaining edge 40 does not hold the mold plate 10 against the base 32 as tightly as did the prior art bolts and screws, the continuous clamping force along each edge 54, 56 holds the mold plate 10 tight enough against base 32 to avoid the compound from leaching out from underneath the mold plate 10.

There is a cut out 48 at one end of the receptor plate 30 to expose both the top and bottom 12, 14 of mold plate 10 and permit the user to grasp the mold plate 10 for removing it from the receptor plate 30. The corners 50 of the mold plate 10 are radiused so that it is easier to insert the mold plate 10 into the receptor plate, and so as to avoid sharp corners and increase handleability.

The receptor plate 30 is preferably made of stainless steel. More preferably the receptor plate 30 is made out of 304 stainless steel. The mold plate 10 may also be made of stainless steel or from a high density polyethylene. Although the mold plate 10 may also be made out of aluminum, it is more difficult to use an aluminum mold with a stainless steel base. Stainless is so much harder than the aluminum that the stainless steel will tend to scar the aluminum and prevent a tight fit. Although the receptor plate 30 may be made of aluminum, it is harder to fabricate aluminum into the preferred form of the receptor plate 30. Most preferably the mold plate 10 and receptor plate 30 are both made of a stainless steel.

In one method of fabricating receptor plate 30, the receptor plate 30 is stamped out of a flat sheet of stainless steel. A press is then used to make the retaining members 34, 36, and 38. The corners 52 of the receptor plate 30 are open to make it easier to fabricate plate 30. By having the corners 52 open, when the retaining members 34, 36, 38 are made, the edges of the stainless steel sheet will not tend to overlap at each corner. Although the open corners 52 are principally for fabrication, if the mold plate 10 gets tight in the receptor plate 30, the open corners 52 may be used to apply a force to push the mold plate 10 out of the receptor plate 30.

In production of the mold assembly, the mold plates 10 are sized first and then the receptor plates 30 are fabricated to fit the receptor plate 30 to the dimensions of the mold plate 10. This allows all the mold plates 10 and receptor plates 30 to be identical, thereby allowing the mold plates 10 to be used interchangeably with the receptor plates 30. Since the mold plates 10 are used with the receptor plates 30 as a unit, a ½ inch mold plate is used with a ½ inch receptor plate and a ¼ inch mold plate is used with a ¼ inch receptor plate.

Referring now to FIGS. 3A and 3B, there are shown alternative retaining members of receptor plate 30. FIG. 3A shows junction 44 configured to include hinges 45 which allow the L-shaped retaining edge 40 and retaining wall 42 to rotate, by means of the hinge 45, along the axis 47 parallel to the length of base 32. Alternatively, as shown in FIG. 3B, junction 44 may be eliminated by disconnecting retaining members 34, 36, 38 from base 32. A U-shaped sliding mechanism or extended clip 49 may be slipped over the edges 54, 56 of mold plate 10 and the bottom of base 32. The clips 49 separate the retaining members from the base 32. An automated clamp may also be used but is not preferred. These embodiments eliminate the sliding action of the mold plate and replace it with a rotating or sliding action of a retaining means. These embodiments continue to reduce the manual actions required as compared to the prior art.

When using with liquid compounds or compounds which have little or no consistency, it may be necessary that the mold plate 10 be mounted on receptor plate 30 so tightly that a tool may be needed to insert and remove the mold plate 10 from the receptor plate 30. The tool may grip onto one end 16, 18 of the mold plate 10, such as end 18 shown in FIG. 4, to remove it from the receptor plate 30. A fixture may also be used in which the receptor plate 30 is held in place while the mold plate 10 is being removed with the tool. It should also be appreciated that there may be an extension or projection on one end of the mold plate 10 to provide a gripping surface to assist in removing mold plate 10 from receptor plate 30.

Additional means may be used to seal the mold plate 10 with the base 32 when using the mold assembly with liquid compounds or compounds which have little or no consistency. Veterinarian medicinal compounds have more consistency than pharmaceutical compounds. Thus, pharmaceutical compounds, having a much lighter consistency due to a greater liquid content, may pose leaching problems. Consequently, clearance 46 may require a tighter tolerance. Further, pharmaceutical use may require a sealing effect between the mold plate 10 and receptor 30. Engaging grooves and protuberances may be added to the base 32 of receptor 30 and bottom 14 of mold plate 10, respectively, to closely engage and seal and thus prevent leaching. Grooves and protuberances are not preferred because they add expense and cost.

Referring now to FIG. 4, in operation, end 16 of mold plate 10 is moved forward in the direction of the front of receptor plate 30. The rounded corners 50 are inserted into the openings in retaining members 34, 36. The mold plate 10 is inserted and slidingly received within member 34, 36 until end 16 is received with end retainer 38. Once fully engaged, the sides 20, 22 of mold plate 10 will be flush with retaining walls 42. The retaining member 34, 36, 38 hold bottom 14 against base 32. Subsequently, compound medication may be applied to mold holes 12.

Once the mold plate 10 is assembled with the receptor plate 30, the holes 24 through the mold plate 10 are filled with a compound, such as powdered medicine mixed with a gelatin material. The medication may be blended with a flavored gelatin. A spatula may be used to force the compound into the mold holes 24 and to scrape off the surface of the mold plate 10 to remove excess compound. The mold assembly with compound are then put into a freezer.

The freezer firms up the compound. After several minutes, the mold assembly is removed. Originally the compound is a liquid or paste, but once the compound has been in the freezer, it has sufficient consistency that it can be punched out of the mold plate 10. The mold plate 10 is then slid out of the receptor plate 30 and the tablets are punched out of the holes 24 in the mold plate 10.

The mold assembly may be cleaned after each use or several runs may be made to produce a particular tablet before the mold assembly is cleaned. Sanitary considerations are greater when tablets are being produced for human consumption, and an all stainless product may be required for the mold assembly.

The mold assembly is directed to small quantity production and allows individual pharmacists to compound their own tablets with their own compositions. The mold assembly is simple because typically only a couple hundred tablets are made at a time. Most of these tablets are for specific doses of medicine and it would be unusual to make these tablets on a mass scale, such as thousands of tablets at a time. Therefore, it is preferred that the mold assembly not be complicated or expensive, particularly since only a limited number of tablets with a particular compound is made at one time. Although a lot of tablets may be produced, only small quantities are typically produced with a particular medicine. Often 100 tablets are made at a time.

It should be appreciated that the present invention may be adapted for a more automated production. Referring now to FIG. 5, there is shown a mechanism for removing the tablets from the mold plate 10 and dropping the tablets into packaging. A tool 60, mounted on a jig well known in the art, includes a plurality of projections 62 sized and spaced to be received into one or more rows R and columns C of holes 24 in mold plate 10. A tool 60 is lowered, projections 62 are received in holes 24 and the tablets in the holes 24 are engaged by projections 62 and forced out of the holes 24, thus causing the tablets to be punched out of holes 24 as a group instead of one at a time. The alignment and dimensions of the holes 24 are precise to properly align with and receive projections 62.

The process can be automated by dimensioning the distance between adjacent holes 24 such that the mold may be placed over the top of the packages 64 whereby when a row of tablets is punched out, each of the tablets drops into a packet 66 in the package 64 for the tablets. Thus the holes 24 may be designed to conform with the size of the packets 66 into which the tablets will be packaged. The tablets may then be sealed into the packets 66 of packages 64. This may cause the dimensions of the mold assembly to be longer and wider. Also the number of holes 24 per area of mold plate 10 may be reduced because of the larger sized packaging. Thus, the present invention may be used in a limited production operation where the tablets are also packaged in a packaging operation.

The embodiments of the present invention provide many advantages over the prior art. The mold assembly combines a base to cover the holes of the mold and a lip to hold the mold against the base which previously were separate functions. The receptor plate not only provides a bottom to the mold plate but also includes the fixture for maintaining the mold plate against the base of the receptor plate. All of the separate fasteners required to hold the mold to the base in the prior art have been eliminated. This eliminates the cost of the fasteners and reduces labor costs. The mold assembly has mobility and is easily portable. It has no hardware and is very easy to clean. The mold assembly of the present invention can be stacked where the prior art with screws can not be so easily stacked. By stacking the mold assemblies, space is saved in the freezer or refrigerator. The mold assembly includes only two pieces and only requires a two step operation. The mold assembly provides cost savings because of the ease of operation and use.

The above discussion is meant to be illustrative of the principles and various embodiments of the present invention. Numerous variations and modifications will become apparent to those skilled in the art once the above disclosure is fully appreciated. For example, there are various configurations of junction 28 which result in different types of clamping actions. It is intended that the following claims be interpreted to embrace all such variations and modifications.

What is claimed is:

1. An apparatus for producing tablets from a compound, the apparatus comprising:
a mold having a plurality of holes therethrough;
a base covering said holes; and
retaining members on said base receiving said mold to maintain said mold against said base.

2. The apparatus of claim 1 wherein said retaining members include an extended surface engaging a peripheral edge of said mold to retain said mold against said base.

3. The apparatus of claim 1 wherein said retaining members include an extended retaining edge connected to said base by a retaining wall.

4. The apparatus of claim 1 wherein said retaining members are made by bending a portion of said base into a U-shaped slot for receiving an edge of the mold.

5. The apparatus of claim 1 wherein the holes are spaced equidistantly into rows and columns.

6. The apparatus of claim 1 wherein the mold is made from a material selected from the group consisting of stainless steel, aluminum or high density polyethylene.

7. The apparatus of claim 1 wherein the base is made from a material selected from the group consisting of stainless steel and aluminum.

8. The apparatus of claim 1 wherein said base has perimetrical edges with a first length approximately equal to or lesser than the thickness of said mold and bent at a first angle in relation to said base, and a second length extending from said first length additionally bent at a second angle in relation to said first length.

9. The apparatus of claim 8 wherein said first and second angles are 90 degrees.

10. The apparatus of claim 8 wherein a hinge connects said first length to said base.

11. The apparatus of claim 8 wherein said retaining members include U-shaped clips which engage said mold and base.

12. A method for molding a compound, the method comprising:
inserting a mold into retaining members on a base to cover holes in the mold and to connect the base to the mold;
applying the compound to a plurality of holes in the mold;
cooling the compound to a desired temperature;
removing the mold from the retaining members and base; and
dislodging the compound from the holes in the mold.

13. The method of claim 12 wherein the inserting step is achieved by sliding the mold into the retaining members on the base.

14. The method of claim 12 wherein the inserting step includes rotating or sliding the first and second lengths over the mold and base.

15. An apparatus for producing tablets from a compound, the apparatus comprising:
a mold having a plurality of holes therethrough; and
a receptor plate comprising:
a base; and
a plurality of retaining members;
wherein said receptor plate is shaped so as to slidingly engage said mold.

16. The apparatus according to claim 15 wherein said retaining members are dimensioned so as to slidingly receive said mold.

17. The apparatus according to claim 15 wherein each said retaining member comprises:
a retaining edge; and
a retaining wall extending from said base to said retaining edge.

18. The apparatus according to claim 17 wherein each said retaining edge and said base define a predetermined clearance therebetween.

19. The apparatus according to claim 18 wherein said clearance is substantially the same as the thickness of said mold.

20. The apparatus according to claim 18 wherein said clearance is less than the thickness of said mold such that upon said mold engaging said receptor plate said mold expands each said retaining edge such that each said retaining edge applies a clamping force to said mold.
